(19) United States
(12) Patent Application Publication
(10) Pub. No.: US 2008/0000886 A1
(43) Pub. Date: Jan. 3, 2008

(54) Apparatus for Marking a Vehicle

(76) Inventors: John T. Bell, Kent (GB); Geoffrey F. Hart, Kent (GB)

Correspondence Address: DICKSTEIN SHAPIRO LLP, 1825 EYE STREET NW, Washington, DC, 20006-5403, US

(21) Appl. No.: 11/664,116

(22) PCT Filed: Sep. 30, 2005
(86) PCT No.: PCT/GB05/03783

§ 371 Date: Jul. 20, 2007

(30) Foreign Application Priority Data
Oct. 1, 2004 (GB) 0421863.2

(51) Int. Cl. B23K 26/00

(52) U.S. Cl. 219/121.68

(57) ABSTRACT

In order to allow windows of a vehicle to be marked using a laser in a reliable manner, the present invention provides an apparatus for marking a vehicle comprising a laser emitter (4) for producing a laser beam, laser beam delivery means (5), a marking head (6) comprising means for deflecting the laser beam into a path defining a mark, an arm comprising at least two arm sections (7, 8) articulated with respect to one another, the marking head (6) being mounted on one of the arms, so that the marking head (6) can be moved into contact with the part of the vehicle to be marked. Means are provided for driving the arm sections (7 and 8). A controller (17) is provided for controlling the driving means, laser emitter (4) and the marking head (6) is provided so that a mark can be made on a selected part of the vehicle.

The present invention relates to an apparatus and a method for marking a vehicle.

Vehicle marking is particularly important as a method of discouraging theft of vehicles. If at least one indelible mark is applied to a part of the vehicle, it will be difficult for thieves to disguise the identity of the stolen vehicle when they try to sell it. Indelible marks can be applied to secret or enclosed spaces within the structure. However, such marks have the disadvantage that they are not readily viewable by purchasers. A highly visible indelible mark is required to deter theft.

Accordingly, a practice has arisen of applying marks to an outer surface of a vehicle in a position in which they will be readily visible. These marks may be made in any suitable part of the structure, however, it is particularly preferred to make the marks in the windows of the vehicle. It is usually not possible to remove a mark from window glass. The windows of the vehicle cannot be covered up or painted over by a thief to disguise the identity of the vehicle. It is impossible remove an etched mark from window glass without either repolishing the entire surface or leaving a clear indication that the glass has been tampered with. Repolishing the glass would require removal of the glass from the vehicle.

It is well known in the art to apply a mark to the window glass of a vehicle by an etching process. Typically, a stencil is used defining a unique code which allows the vehicle to be identified, an etching material being applied through the stencil to the window glass. Typically, the etching material comprises hydrogen fluoride or related materials. However, these are very dangerous materials to handle and the process is extremely difficult to automate.

A system of making marks in glass using a laser has been proposed, for example in U.S. Pat. No. 5,298,717. In this case, a carbon dioxide laser is used which generates a laser beam which will make a mark on the surface of glass. The system further includes a controller for providing signals for controlling the laser beam and a laser beam steering system comprising a pair of mirrors whose axes are orthogonal. In use, the laser beam impinges first on one mirror and then on the second mirror, the angular positions of the mirrors being altered in response to signals from the system controller to move the position of the laser beam and thereby cut a suitable pattern onto the glass. In one embodiment, the laser is suspended by a flexible mounting from a gantry which is located above a vehicle station. In another embodiment, the laser itself is mounted on the gantry, a flexible arm being provided, down which the laser beam may be directed to a marking head which contains the mirrors for deflecting the laser beam in the required pattern. The laser emitter mounted on the gantry can be displaced from front to rear of the vehicle as required by the operator.

International patent publication No. WO03/072297 discloses an apparatus for marking a vehicle using a laser beam, having a gantry which allows a laser emitter to be moved to many different positions so that many parts of the vehicle can be marked thus allowing a relatively short laser beam conduit to be employed. The laser emitter may be a radio frequency excited carbon dioxide slab laser.

All of the systems require a human operator to control the process. This can give rise to errors in operation of the system.

Although it is known to apply markings by various techniques to components of vehicles before they are assembled, it is preferable, from the point of view of process control, to apply security parts to the vehicle once it is complete.

The present inventors have realised that a laser apparatus can be used to apply marks to a complete vehicle, in an automated system, if the laser head, which produces the distinctive mark, is mounted on an articulated arm, also referred to as a robot arm, which is controlled by a controller to bring the laser head into contact with different parts of the vehicle in succession. The articulated arm can allow many different parts of the vehicle to be accessed from a single device. A high level of automation and central control can be obtained.

Accordingly, the present invention provides an apparatus for making an identification mark on a vehicle, for identifying the vehicle, comprising a laser emitter for producing a laser beam, laser beam delivery means for delivering the laser beam to a laser head, the laser head being mounted on an arm comprising at least two arm sections articulated with respect to one another, so that the laser head can be moved into contact with a part of the vehicle to be marked, driving means for driving the arm sections so that they can move with respect to one another and a controller for controlling the driving means and the laser emitter so that the laser head can make a mark on a selected part of the vehicle.

The apparatus of the present invention allows an identification mark, which may comprise a relatively small but complex mark (as described further below) to be made on a part of a vehicle, for example a window of a vehicle, so that the vehicle can be identified from other vehicles. The controller may be adapted to control the positioning of the laser head so that a marking head (which will be described further below) can be used to make a mark or the controller can be used to control the movement of the laser head itself to make the mark.

Preferred features of the invention will be described further below.

Articulated Arm and Driving Means

The present invention must comprise, inter alia, a laser head mounted on a delivery arm comprising at least two arm sections articulated with respect to one another and means for driving the arm sections with respect to one another.

These components may be provided by many conventional types of robot arm, for example as used for the welding or cutting of metal using laser beams. For example, the robot arm described in EP-A-1254747 may be employed.

The skilled person will be aware of techniques for designing and controlling such a robot arm so that a laser head can be bought into contact with any selected part of a vehicle to be marked.

The articulated arm may comprise any suitable number of articulated sections which are articulated with respect to one another.

Known designs of robot arm may provide sufficient fine control of the position of the laser head to make the kind of alphanumeric mark which is preferably used in the present invention. For example, such designs of robot arm may be known for cutting fine patterns in relatively thin gauge material. The present invention envisages the use of such a design of arm to make an identification mark on a vehicle, in a novel manner.

However, the apparatus of the present invention may be required to make a mark which is too fine to be achievable by means of the arm. In this case, a separate marking head, mounted on the arm, may be used.

Accordingly, the laser head preferably further comprises a marking head mounted on the laser beam delivery arm, the marking head comprising means for deflecting the laser beam into a path defining a mark, so that a mark can be made without moving the marking head with respect to the part of the vehicle to be marked

The skilled person will be able to select whether to use a marking head in which the laser beam is deflected into a path defining a mark without moving the marking head with respect to the part of the vehicle to be marked or a mark—writing laser head in which the laser beam is deflected into a path defining a mark by moving the laser head itself. This will depend on the complexity of the mark formed and the speed of writing required.

Suitable designs of marking head will be described further below.

In order to allow selected parts of the vehicle to be marked, the laser head should be selectively placeable at selected positions displaced from one another in three dimensions taken with respect to the vehicle.

For example, the laser head must be moveable towards and away from the vehicle and up and down. The laser head must be moveable along the longitudinal length of the vehicle. This can be achieved by providing an articulated arm which is capable of displacing the laser head in a longitudinal direction which is parallel to the longitudinal direction of the vehicle. Alternatively, the vehicle may be mounted on a moving production line which is moved past the laser head.

The arm sections may move with respect to one another by rotation about an axis which is substantially parallel to the axis of at least one of the arm sections or at an angle to the axis of one of the arm sections. The arm sections may also be telescopic if necessary.

The laser emitter may be mounted on the arm.

In a particularly preferred embodiment, the apparatus comprises a base structure, a first arm section which is rotatably mounted with respect to the base structure at one end and at the other end is rotatably mounted with respect to the second arm section, the laser emitter being mounted on the first arm section or the second arm section.

In this way, the laser beam path from the laser emitter to the laser head can be made relatively short, to reduce power losses and to simplify alignment of the laser beam and assembly of the apparatus.

The laser head is preferable rotatably mounted with respect to the second arm section. Preferably, it is mounted so that it is rotatable with respect to the second arm section about at least one and preferably two axes which are both at an angle to the axis of the second arm section. Preferably, the laser head is rotatable with respect to the second arm section about an axis which is parallel to the axis of the second arm section.

The laser beam delivery means may comprise any suitable means for delivering the laser beam. For example, it may comprise hollow tube sections, the laser beam being delivered substantially down the axes of the hollow tube sections. Laser beam turning mirrors may be provided where the first arm section is articulated to the second arm section and where the laser head or marking head is mounted to the second arm section. Alternatively, a fibreoptic cable for transmitting laser beam may be used. The laser beam delivery means may be integrally formed with a least one of the arm sections or it may be separate from the arm sections.

In order to allow both sides of a vehicle to be marked, the articulated arm itself may be mounted on a gantry for traversing from one side of the vehicle to another.

Alternatively, there may be at least two laser emitters, mounted on each side of the vehicle station. Each laser emitter may be associated with a respective articulated arm and marking head.

Driving Means

The arm sections of the articulated arm may be moved with respect to one another by any suitable means. For example, electric motors may be provided. Preferably, they are stepper motors to provide fine control of movement of the arm sections. Alternatively, pneumatic or hydraulic cylinders may be provided.

Laser Emitter

In order to mark windows of a vehicle, the glass itself may be marked or, alternatively, the organic interlayer formed between sheets of laminated glass may be marked. In the first process, a laser beam must be used which is strongly absorbed by glass. It is found that the laser beam emitted by a carbon dioxide gas laser (having a wavelength of 10.6 micrometers) or an excimer laser is suitable for this purpose.

For the second approach, a laser beam may be used which is not absorbed by glass but is absorbed by the organic interlayer. In this case, it is found that the beam generated by a neodymium/YAG laser may be used.

It has been found that, in order to avoid cracking the glass and in order to provide a mark which has clearly defined edges, a pulsed laser is suitably used. The frequency of pulsing is suitably in the range 10-100 kHz, more preferably 30-60 kHz, most preferably 35-45 kHz.

The average power of the laser is suitably in the range 5-20 watts.

Further comments on the parameters of the laser operation are given below in the section headed “marking parameters” The carbon dioxide laser may be a high frequency excited carbon dioxide laser, preferably excited at a frequency in the range 10-50 MHz. A radio frequency excited carbon dioxide laser may be used. A slab laser may be used.

Suitable radio frequency excited carbon dioxide slab lasers are manufactured for example by the company Rofin Sinar UK Ltd.

The laser used in the present invention may also be used to mark other parts of the vehicle than the windows, including headlights, plastic parts, painted bodywork or alloy wheel trims.

In an alternative embodiment, a carbon dioxide laser is used which is pulsed by the use of a Q-switch. The Q-switch may be internal to the laser emitter or external to the laser emitter. A Q-switch in the optical path provides laser pulses of extreme short time duration. The Q-switch may be a rotating prism, a Pockels cell or a shutter device to create a pulse.

Suitable forms of light-weight carbon dioxide laser include the SYNRAD (Trade mark) Series 48 lasers or a carbon dioxide laser with an integral Q-switch available from DEMARIA Electro Optic Systems. WO02/082600 discloses a Q-switch cavity dumped carbon dioxide laser for material processing which is suitable for use with the invention.

The laser output may be steady, as in a continuous wave laser, or pulsed.

Where a radio frequency excited carbon dioxide laser is used, a supply of radio frequency (RF) must be provided for exciting the laser. The radio frequency source may be mounted with the laser emitter on the articulated arm. Alternatively, it may be mounted separately and radio frequency supplied by a radio frequency cable to the laser emitter. A radio frequency cable used in the present invention may be of a type known in the art, for example from laser beam welding. For example, a copper cored coaxial cable may be used. Care must be taken when using such a radio frequency transmitting cable to avoid kinking the cable, otherwise damage could ensure and loss of power. Preferably, the radius of curvature for each part of the cable is no less than 30 cm.

Marking Parameters

When making a mark using the laser, it is necessary to deliver sufficient power to the surface being marked to disrupt it to form a mark without causing unnecessary damage. For example, where glass, for example window glass in a vehicle, it is to be marked, it is desirable to form a mark without cracking the glass.

The quality of the mark is affected by the ratio of time that the laser beam is switched on to the time the laser beam is switched off, called the duty ratio. Suitably, the duty ratio is in the range 20%-60% on, more preferably 30-50% or most preferably 35-45% on. For example, at 40 kHz, a 40% duty on ratio in the duty cycle will give a 10 millisecond burst of laser radiation followed by 15 milliseconds in which the laser is switched off.

The scanning speed also affects the quality of the mark. Preferably, the scanning speed is in the range 2000-8000, more preferably 3000-6000, most preferably 4000-5000 mm/s.

It is particularly preferred to match the duty cycle to the scanning speed and the average operating power of the laser. In particular, it is particularly preferred to operate within the parameters 5-20 watts, with a duty cycle in the range 30-50% and a scanning speed in the range 3000-6000 mm per second, more preferably operating at a power in the range 10-15 watts, with a duty cycle in the range 35-45% and the scanning speed in the range 4000-5000 mm/s.

These figures may be represented by a notional value of energy input per unit length. For example, when operating at 10 watts with a 40% duty cycle and a scanning rate of 4,500 mm per second, the energy per unit length is 100.4/4500=approx. 0.9 joules per mm. Preferably, to avoid cracking and to obtain a mark which is clearly defined, the energy per unit length is in the range 0.5-2.0 joules per mm, more preferably 0.75-1.2 joules per mm more preferably 0.8-1.0 joules per mm.

It has been found that, in order to mark window glass of vehicles, it is particularly preferred to use a carbon dioxide laser operating in the range 5-20 watts, more preferably around 10-15 watts.

Identification Mark

The identification mark formed according to the present invention should be capable of identifying a vehicle from other vehicles. Preferably, the identification mark will be unique to that individual vehicle. In order to provide a mark which is capable of identifying an individual vehicle, the mark needs to be relatively complex. Suitably, the mark comprises numbers, letters or both and is of sufficient length to form a unique mark.

The mark may further comprise graphic elements, for example a logo or other symbol.

The identification mark may include information for example contact telephone numbers, email addresses etc.

The identification portion of the mark is suitably of sufficient size to be visible by a person inspecting the vehicle but not so large as to affect the view through the window of the vehicle. For example, the identification mark preferably comprises characters which are at least 1 mm in height, being suitably of 6, 8, 10 or 12 pt size. Preferably, the characters do not exceed 2 cm in maximum height. The entire mark is suitably of dimensions from 2 cm or more in length up to 10 cm or less in length and 2 cm or more in height up to 10 cm or more in height. Preferably the identification mark comprises a string of characters of at least 6 characters in length, preferably at least 8 characters in length and most preferably at least 10 characters in length.

Marking Head

In the marking apparatus of the invention, the laser emitter produces a pulsed or continuous laser beam which is preferably delivered via the laser beam delivery means to the marking head.

The marking head is adapted to contact the part of the object to be marked, and deliver the laser beam to the part of the object to marked, the marking head further including means for deflecting the laser beam to define a pattern required to form the mark without moving the marking head with respect to the vehicle.

As noted above, the mark formed may be of any suitable type, for example an alphanumeric code of a specified number of characters in a specified number of rows. It may comprise a graphic symbol, logo or other mark. In all cases, it is necessary to move the laser beam across the surface of the path of the part of the vehicle to be marked in two dimensions. The mark may be formed in a dot matrix pattern by scanning the laser beam across the surface of the part of object to be marked in a rasterscan pattern. Alternatively, the characters can be scribed individually.

In order to deflect the laser beam in two dimensions, any suitable system may be used. However, preferably at least one mirror is provided which is rotatable about at least one axis to deflect the laser beam. Preferably, a pair of mirrors in sequence are used, each intersecting the laser beam and each being rotatable about a respective fixed axis. Preferably the axes about which the mirrors are rotatable are orthogonal to one another. The rotation of the mirrors is controlled by any suitable means. Preferably, the rotation of the mirrors is controlled by galvanometers which are found to move quickly and effectively. A suitable arrangement is described for example in U.S. Pat. No. 5,298,717.

The marking head will further comprise a light-tight casing for presenting leakage of laser radiation, to protect operators.

A part of the casing will comprise a window of a material which is transparent to the laser radiation used. For example, where a carbon dioxide laser is used (as discussed further below), the window may comprise germanium.

The marking beam preferably includes a safety device. The safety device suitably comprises at least one switch which is only closed when the marking head is in the correct position on a part of the object to be marked, in order to prevent the apparatus being accidentally fired. Preferably, there are at least three switches, all of which have to be depressed when the marking head is in correct position, the laser being inoperable until all three switches are depressed. This ensures that the marking head is in position before the laser is fired to prevent distortion of the mark applied and to prevent escape of laser radiation.

The marking head may further comprise a resilient seal around the marking head to further prevent leakage of radiation.

Means may be provided for cleaning the laser beam window to prevent loss of light or focus. For example, an air jet may be provided for blowing deposits off the laser beam window and to prevent contamination of lenses.

Preferably, means are provided for collecting material released during the marking of the window glass. For example, glass dust may be collected. The collecting means may comprise a simple container. However, in order to catch the relatively light particles of glass, an adhesive surface may be provided. For example, a piece of double sided adhesive tape may be employed.

Preferably, the marking head is of light weight. Preferably, the weight of the marking head does not exceed 5 kg, being preferably less than 3 kg suitably less than 2 kg. A suitable design of marking head is the HS7 available from Scanlab (trade mark). Other suitable marking heads can be obtained from the manufacturer Rofin Sinar.

Controller and Input

In order to control the operation of the laser emitter, the articulated arm and the marking head to produce a required mark, a controller is required. Data may be input to the controller by input means.

Where the mark to be made on the object comprises a character as described above, it is necessary to deflect the beam in at least two directions and to switch the beam on and off whilst forming the characters. Preferably, at least one of the position of the beam and the duration of the beam, preferably both, are controlled by a controller. The controller may be mounted in the marking head, in the laser apparatus or at another position on the apparatus of the invention.

Where security codes are to be marked onto object, it is generally necessary for at least one component of each code to be unique to the vehicle which is being marked. Accordingly, input means may be provided for inputting to the controller the code required for each vehicle. The code may be transmitted to the controller via a communications network such as the Internet or by dedicated communication lines such as telephone lines. Alternatively, the controller may be provided with a scanner for reading information relating to the code to be marked on each vehicle. For example, the scanner may comprise a bar code reader of the sort well known in the art.

The controller suitably comprises a personal computer or a similar computer programmed to control the apparatus.

For example, the controller may comprise a processor connected to at least one memory, the memory being for storing data comprising, for each vehicle to be marked, vehicle marking data (for example the vehicle identification number), the code to be marked on the vehicle and the date on which the mark is made. Preferably, an input is provided for inputting to the processor the vehicle data, the processor being adapted to enter the vehicle data into the memory.

The processor is preferably further connected to a laser controller. In order to mark a given vehicle, its Vehicle Identification Number, which is a unique number assigned to that vehicle by an international organisation, may be input to the processor. The processor then extracts from the memory code data required to be marked on the vehicle. The code data is then transferred to the laser controller. The laser controller itself is connected to the laser and, separately, to the laser head. The laser controller controls the laser by switching it on and off, in co-ordination with the movement of the laser beam by the laser head so that the required code is marked onto the vehicle. Once the vehicle has been marked the required number or times, a signal can be input to the processor to indicate that the vehicle has been marked. The processor then writes the confirmation of marking and the date of marking into a second memory.

The processor is preferably configured to delete the marking data from a memory to prevent the same mark being applied to a second vehicle. The marking data may be entered into the second memory to provide a record.

The apparatus of the invention may be used to mark any suitable part of a vehicle. However, it is particularly preferred to use the apparatus of the invention to mark at least one window of the vehicle.

The controller preferably further comprises a signal cable for transmitting control signals to the laser emitter, the driving means head and the marking head (where used). Where the laser emitter is connected to the marking head by a flexible laser beam delivery means, a signal cable for the marking head suitably passes along the laser beam delivery means. For example, they may lie side by side. The signal cable may be formed integrally with the structure of the laser beam delivery means.

The controller may be portable, for example being mounted on a portable structure with the laser emitter. Alternatively, the controller may be fixed, being connected to the laser emitter, the driving means and (where used) the marking head by a signal cable. For example, the signal cable may extend coaxially with a power cable for transmitting power to the laser emitter, driving means and marking head.

The present invention will be described by way of example only with reference to the accompanying drawings, in which:

### BRIEF DESCRIPTION OF THE DRAWINGS

FIG. 1 is an isometric view of an apparatus for marking a vehicle according to the present invention.

FIG. 2 is a schematic side view of a laser emitter and a marking head mounted on an articulated arm.

FIG. 3 is a sketch isometric view, at enlarged scale, of the mounting of the marking head on the laser emitter.

FIGS. 4 and 5 show alternative embodiments of the mounting of the marking head of the laser emitter.

FIG. 6 is a sketch illustration of the control system used in the present invention.

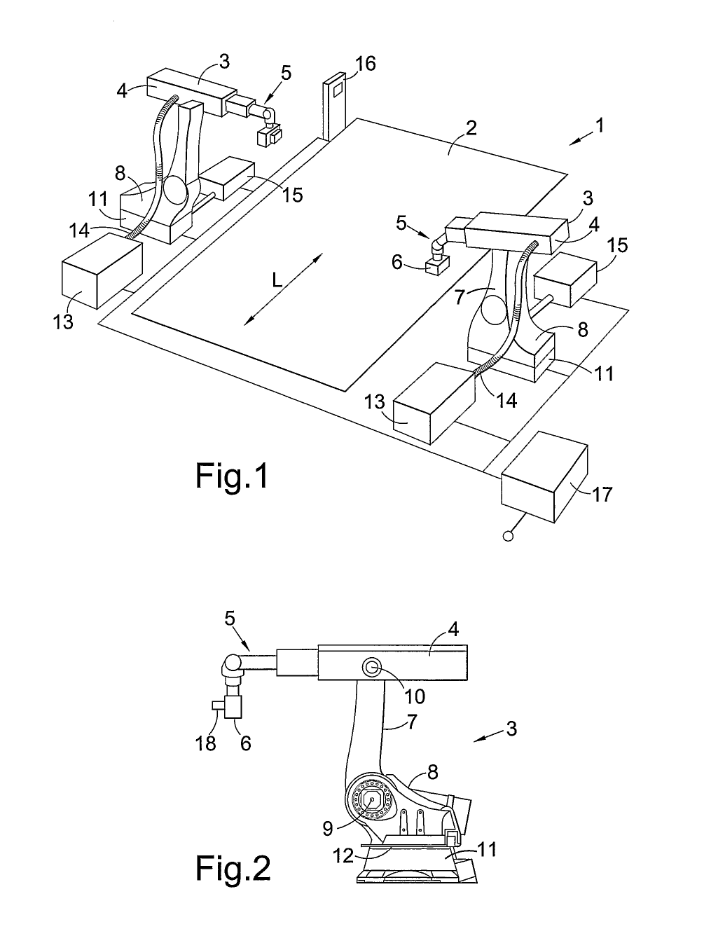

### DETAILED DESCRIPTION OF THE DRAWINGS

The laser marking apparatus of the present invention is generally designated 1. It comprises a vehicle station 2 in which a partly complete or complete vehicle, with windows in place can be located. The vehicle can be driven into the vehicle marking station or it can be mounted on a production line which moves through the vehicle station 2.

On either side of the vehicle station 2 there are two lasers marking robots 3. These are illustrated further in FIG. 2. Each laser marking robot 3 comprises a laser emitter 4, laser beam delivery means 5, a marking head 6 and an articulated mounting comprising two arm sections 7, 8 which are rotatable with respect to one another at a pivot 9 and with respect to the laser emitter at a pivot 10. Finally, the robot comprises a base 11. The articulated arm 8 is rotatably mounted at a pivot 12 around a vertical axis on the base 11.

In a preferred embodiment, as will be described further below, the laser emitters are each radio frequency excited carbon dioxide slab lasers.

In order to operate these lasers, a supply of radio frequency is required to excite the lasers. Each marking robot 3 is therefore provided with a source of radio frequency 13. Radio frequency is transmitted via a conventional radio frequency transmitting armoured cable 14 to the laser emitter 4. Each robot further comprises a cooling water supply 15 in a manner known in the art.

A bar code reading station 16 is provided for reading a bar code provided on a vehicle located in the vehicle station 2. A central controller 17 is provided which is configured to receive signals from and control each of the laser robot 3, the laser emitters 4, the marking head 6, the articulated arms 7, 8, the laser beam delivery means 5, the radio frequency supply 13 and the cooling water supply 15.

In the embodiment shown, the robots 3 are configured so that they rotate about vertical axes on their bases. This enables each marking head 6 to be moved in a longitudinal direction L with respect to a vehicle in the vehicle station 2. The articulated arms 7 and 8 and the laser emitter 4 can be moved about pivots 9 and 10 around horizontal axes, allowing the marking head 6 to be raised and lowered and moved closer to or further from a vehicle in the vehicle station 2.

In order to make a mark on a window of a vehicle, close and accurate conformation of the marking head to the window of the vehicle is required.

In practice, each marking head is provided with a rubber seal 18 which, in use, has to be pressed against the window of a vehicle so that it is in close contact, before any marking occurs.

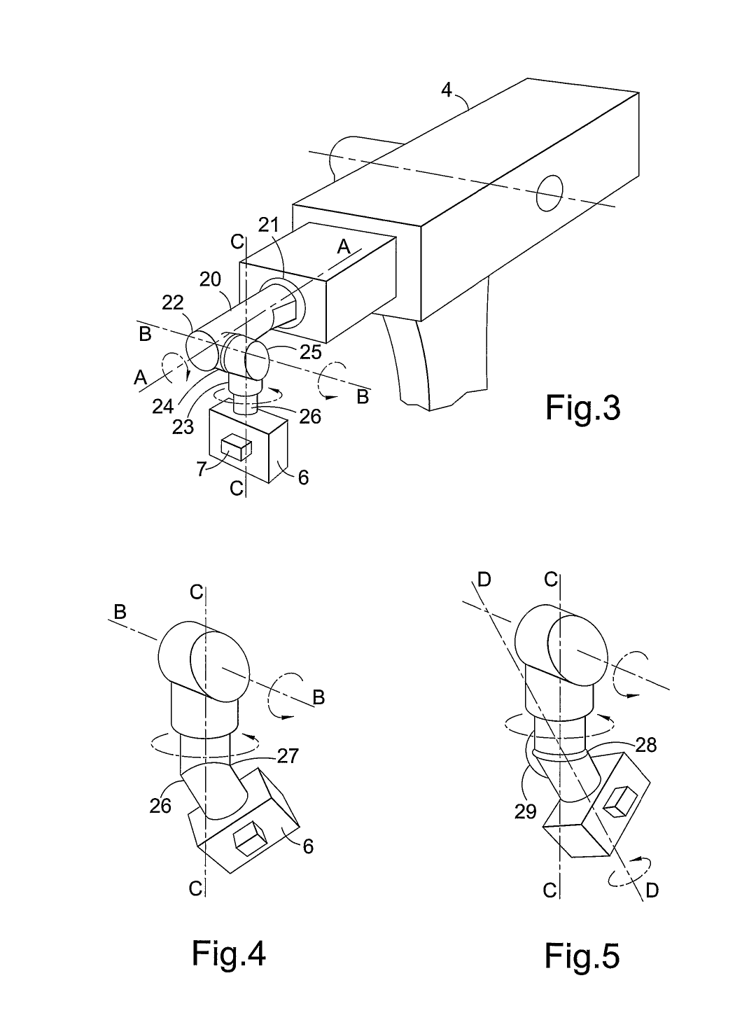

Close control of the positioning and conformation of the marking head is obtained by the arrangement shown in FIGS. 3-5.

As can be seen in FIG. 3, the laser beam delivery means comprises a first conduit section 20 for delivering a laser beam. The conduit section 20 is rotatably mounted with respect to the laser emitter 4 at a bearing 21 around an axis A-A. Rotation of the conduit section 20 about the axis A-A swings the marking head 6 up and down and from left to right.

At the end of the conduit section 20 there is a fixed laser turning mirror 22 which deflects the laser beam towards the right hand side of the figure. It is deflected into a short laser conduit section 23. This conduit section 23 is rotatably mounted with respect to the first conduit section 20 about a bearing 24 so that the whole structure is rotatable about the axis B-B. The second conduit section 23 comprises a laser beam turning mirror 25 which deflects the laser beam in a downward direction. Rotation of the second conduit section around its axis B-B raises or lowers the marking head and tilts it with respect to the vertical axis, which is typically required for vehicle windows which are sharply inclined with respect to the vertical direction. Finally, there is a third conduit section 26 which is mounted in a bearing in the second conduit section 23 so that the third conduit section can be rotated about the axis C-C. This adjusts the direction in which the marking head 6 faces in the horizontal plane. This allows the marking head 6 to be placed in contact both with front and rear windscreens of a vehicle and side windows.

FIG. 4 shows an alternative embodiment, in which the third conduit section 26 has a rigid knuckle 27 in it, with a turning mirror inside the conduit section (not shown) for directing the laser beam through the angle of the knuckle. This is suitable when a more tilted configuration of the marking head 6 is required. In a further modification, there may be two right angle turning mirrors in sequence. The optical axes of the turning mirrors may be at an angle to each other.

FIG. 5 shows a yet further embodiment in which, instead of a fixed knuckle, there is a rotatable bearing 28 with a turning mirror 29 allowing the marking head to be rotated with respect to the third conduit section around an axis D-D which is at an oblique angle to the axis C-C.

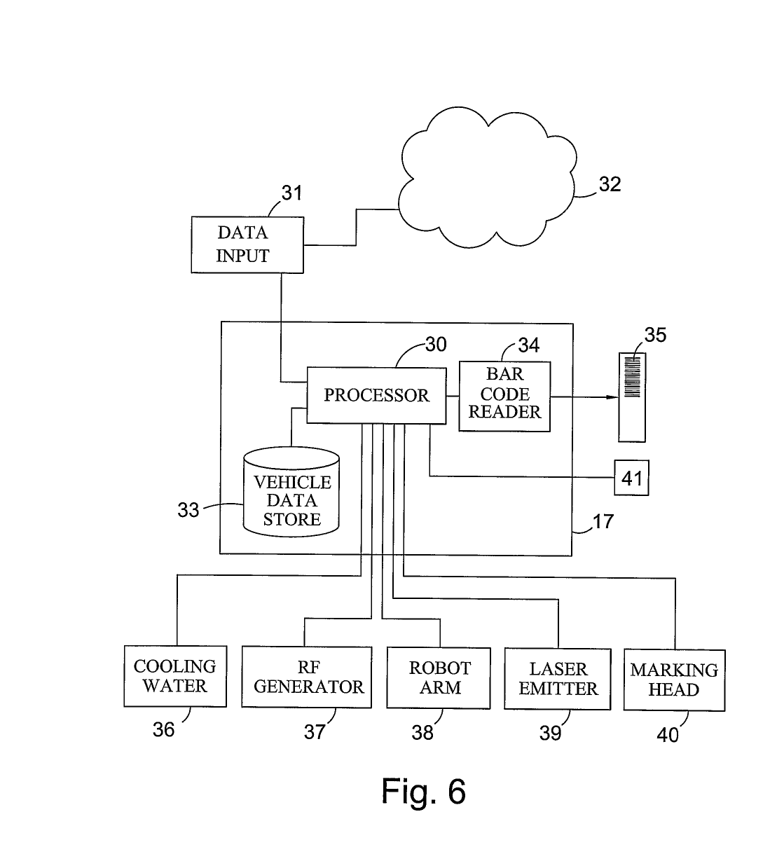

FIG. 6 shows a schematic illustration of the control system for the vehicle marking apparatus 1. Inside the controller 17 there is a processor 30. In order to prepare the apparatus for operation, data is provided by the data input 31. Data can be input by any suitable means, for example by manual input, by uploading from data storage means such as discs or by transmission from the internet 32, for example.

For each vehicle, the following data will be required:

The vehicle identification number (VIN)

An indication of vehicle model and number of windows to be marked, including conformation and arrangement of those windows)

An additional security mark to be made on the windows

This data is received from the data input and stored in a vehicle data store 33. In operation, when a vehicle arrives in the vehicle station 2, the bar code 35 on the vehicle is read by the bar code reader 34 which signals the identification of the vehicle, (suitably the Vehicle Identification Number) to the processor 30. The processor 30 then obtains from the vehicle data store 33 information defining the position of each window and the mark to be made on each window.

Then, command signals are given to each of the cooling water supply 15, the radio frequency generator 14, the robot arm, the laser emitter 4 and the marking head (36-40) to control movement of these parts or operation of these components so that the marking heads is brought in succession into contact with each window in the correct configuration for the correct mark to be made on that window.

The processor determines when the operation is complete. When the operation is complete, the processor may give a signal at 41 to a factory operating system to signal the vehicle to be removed from the vehicle station 2 and for another vehicle to be delivered.

The present invention has been described above purely by way of example and modifications can be made within the spirit of the invention which extends to equivalents of the features described. The invention also consists in any individual features described or implicit herein or shown or implicit in the drawings or any combination of any such features or any generalisation of any such features or combination.

1. Apparatus for making an identification mark on a vehicle for identifying the vehicle, comprising:
a laser emitter for producing a laser beam;
laser beam delivery means for delivering the laser beam to a laser head;
an arm comprising at least two arm sections articulated with respect to one another,
the laser head being mounted on one of the arms so that the laser head can be moved into contact with a part of the vehicle to be marked,
driving means for driving the arm sections with respect to one another,
a controller for controlling the driving means and, the laser emitter so that the laser head can make a mark on a selected part of the vehicle.

2. An apparatus according to claim 1, wherein the laser is a radio frequency excited carbon dioxide slab laser.

3. An apparatus according to claim 1, wherein the laser is a Q switched laser.

4. An apparatus according to claim 1, wherein the driving means is for driving the arm sections so that the mark is made by movement of the arm sections with respect to the part of the vehicle to be marked.

5. An apparatus according to claim 1, further comprising a marking head mounted on the laser beam delivery arm, the marking head comprising means for deflecting the laser beam into a path defining a mark, so that a mark can be made without moving the marking head with respect to the part of the vehicle to be marked.

6. An apparatus according to claim 1, wherein the arm is capable of displacing the laser head in a longitudinal direction which is parallel to the longitudinal direction of the vehicle.

7. An apparatus according to claim 1, wherein the vehicle is mounted on a moving production line which is moved past the laser head.

8. An apparatus according to claim 1, wherein the apparatus comprises a base structure, a first arm section which is rotatably mounted with respect to the base structure at one end and at the other end is rotatably mounted with respect to a second arm section, the laser emitter being mounted on the first arm section or the second arm section.

9. An apparatus according to claim 8, wherein laser head is rotatably mounted with respect to the second arm section.

10. An apparatus according to claim 9, wherein the laser head is mounted so that it is rotatable with respect to the second arm section about at least one and preferably two axes which are both at an angle to the axis of the second arm section.

11. An apparatus according to claim 1, wherein a fiber optic cable is used for transmitting the laser beam.

12. A method of marking a vehicle comprising using the apparatus of claim 1.

13. (canceled)

14. (canceled)
